(19) United States
(12) Patent Application Publication
(10) Pub. No.: US 2015/0327029 A1
(43) Pub. Date: Nov. 12, 2015

(54) TEXT MESSAGING TO DEVICES

(71) Applicant: TollShare, Inc., Danville, CA (US)

(72) Inventors: Murali M. Karamchedu, Portland, OR (US); Ravi Asnani, Los Angeles, CA (US)

(73) Assignee: TollShare, Inc., Danville, CA (US)

(21) Appl. No.: 14/274,205

(22) Filed: May 9, 2014

(51) Int. Cl. H04W 4/12; H04L 29/12; H04W 4/18

(52) U.S. Cl. CPC H04W 4/12; H04W 4/18; H04L 61/106

(57) ABSTRACT

Methods, apparatuses, and computer-readable media directed to mnemonic-based text messaging are described. A text messaging application (“TMA”) may be configured to operate to facilitate entry of a text message to a business or a device. The text message may include one or more instructions that may be recognized by the business or the device to perform one or more actions. The TMA may be configured to facilitate entry of a text message that includes a mnemonic for the business or device. The TMA may be configured to resolve the mnemonic with a business/device mnemonic service and to send the text message to a destination client device. The text message may also include abbreviated vocabulary, which may be known to a vocabulary service, which may be configured to translate the abbreviated vocabulary into translated text to be included in the text message. Other embodiments may be described and claimed.

### TECHNICAL FIELD

The present disclosure relates to the field of data processing, in particular, to apparatuses, methods and storage media associated with messaging between devices.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Messaging and other modern, asynchronous communication techniques, are increasingly popular as mobile devices become more and more common. In particular, businesses and other non-personal entities find themselves communicating using Twitter and other modern communication paradigms.

However, one paradigm that is sometimes difficult for businesses is text messaging (which may include, in various examples, transmission of text, images, audio and/or video through various communication protocols). While businesses may wish to encourage short-form communication through text messaging, text messaging often requires a sender to know a specific communication address, such as a phone number or IP address in order to send the text message. However, this may discourage messaging to businesses, because individuals may not know such a communication address for a business, and may be disinclined to look it up.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the Figures of the accompanying drawings.

FIG. 1 illustrates an example arrangement for a first use case of mnemonic-based text messaging, in accordance with various embodiments.

FIG. 2 illustrates an example arrangement for a second use case of mnemonic-based text messaging, in accordance with various embodiments.

FIG. 3 illustrates an example arrangement for a third use case of mnemonic-based text messaging, in accordance with various embodiments.

FIG. 4 illustrates an example process for setting up mnemonic-based text messaging, in accordance with various embodiments.

FIG. 5 illustrates an example process for performing mnemonic-based text messaging, in accordance with various embodiments.

FIG. 6 illustrates an example computing environment suitable for practicing various aspects of the present disclosure, in accordance with various embodiments.

FIG. 7 illustrates an example storage medium with processor executable instructions configured to enable an apparatus to practice various aspects of the present disclosure, in accordance with various embodiments.

### DETAILED DESCRIPTION

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous. The description also uses the term “programmable instructions,” and “business or device instructions.” “Programmable instructions” refer to processor executable assembler or machine instructions, or high level programming instructions that can be compiled or interpreted into executable assembler or machine instructions. Whereas “business or device instructions” refer to high level commands of a business or device language with semantic meanings to the business or device.

As used herein, the term “logic” and “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

In various embodiments, methods, systems, apparatuses, devices, and computer-readable media directed to mnemonic-based text messaging are described. It should be noted that, in various embodiments, text messaging may include various forms of asynchronous communication, including sending of text, images, audio, video, or combinations thereof. For the sake of simpler description, however, the term “text messaging” will be used herein and will be understood to include one or more of these communication techniques. In various embodiments, a text messaging application (“TMA”) may be configured to operate on a source client device to facilitate entry of a text message to a business or a device. The text message may include one or more business or device instructions that may be recognized by the business or the device. Based on the business or device instructions received in the text message, the business or device may perform one or more actions. In various embodiments, the text message may be sent via various text messaging protocols configured to facilitate transmission of text messages (including sending of text, images, audio, video, or combinations thereof, as described above). In various embodiments, the text messaging protocol may include short message service (“SMS”), multimedia messaging service (“MMS”), and/or IP-based messaging protocols, such as, for example, protocols used in the iMessage® service.

In various embodiments, the TMA may be configured to facilitate entry of a text message that includes a mnemonic for the business or device that is registered with a business/device mnemonic service (“BMS”). In various embodiments, the TMA may be configured to resolve the mnemonic with the BMS and to send the text message to a destination client device (such as the registered device or a device associated with the registered business).

In other embodiments, the text message may include abbreviated vocabulary. This abbreviated vocabulary may be known to a vocabulary service (“VS”), which may be configured to translate the abbreviated vocabulary into translated text to be included in the text message when it is presented to the destination client device. In various embodiments, the abbreviate vocabulary may include one or more business or device instructions which may be performed by the business or device receiving the text message. Other embodiments and implementation details are described below.

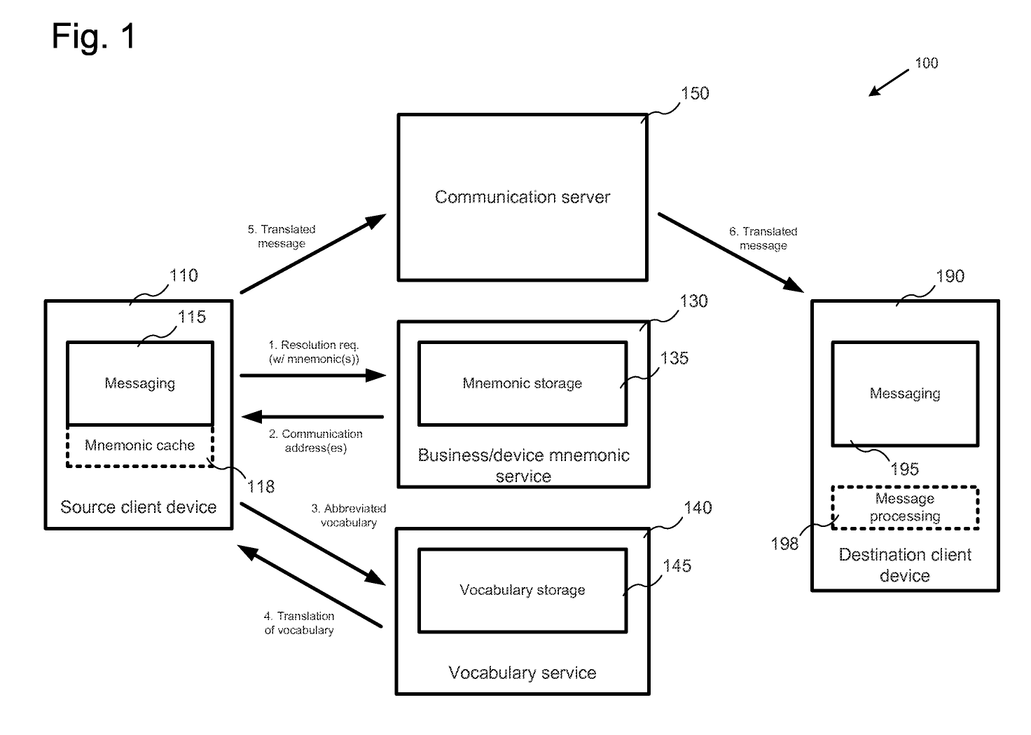

Referring now to FIG. 1, an example arrangement 100 for a first use case of mnemonic-based text messaging is shown in accordance with various embodiments. In various embodiments, a user of a source client device 110 (“SCD 110”) may seek to send a text message (such as described above) to a destination client device 190 (“DCD 190”). In various embodiments, the DCD 190 may be under control of, or otherwise associated with, a business or other non-personal entity. In various embodiments, the SCD 110 and/or DCD 190 may include various types of devices, such as mobile devices, mobile phones, tablet computers, laptop computers, desktop computers, and/or other devices. In various embodiments, the SCD 110 and DCD 190 may be configured to send and/or receive communications via one or more text messaging protocols. In various embodiments the text messaging protocols may include one or more communications protocols such as, for example, short message service (“SMS”), multimedia messaging service (“MMS”), and/or IP-based messaging protocols, such as, for example, protocols used in the iMessage® service. In various embodiments, the SCD 110 and/or DCD 190 may be configured to receive communications via the text messaging protocols at one or more communication addresses. In various embodiments, the communication addresses may include various types of address, including phone numbers (such as for SMS or MMS communications) or IP addresses. In various embodiments, such communications may mediated by a communication server 150 (“CS 150”). In various embodiments, the CS 150 may be configured to communicate with the SCD 110 and DCD 190 via different text messaging protocols.

In various embodiments, the SCD 110 and DCD 190 may include respective text messaging applications 115 and 195 (“TMAs 115 and 195”), which may be configured to send and receive text messages, respectively. In various embodiments, the TMAs 115 and 195 may be configured to receive messages generated by users, such as by accepting text, audio, images, video, etc. entered or otherwise received on the SCD 110 or DCD 190. In various embodiments, one or more of the TMAs 115 and 195 may include an interface configured to operate between a user of the SCD 110 and/or DCD 190 and traditional text messaging applications (not illustrated). In various such embodiments, the one or more TMAs 115 and 195 may be to provide one or more of the mnemonic-based text messaging techniques described herein (and/or the abbreviated vocabulary techniques described herein) on top of the facilities provided by the traditional text messaging applications. Thus, in such embodiments, the use of mnemonics to sends text messages to businesses or devices may be utilized without requiring a change in an underlying text message protocol used by the SCD 110 and/or the DCD 190. In other embodiments, one or more of the TMAs 115 and 195 may be configured to perform actual sending and/or receiving of text messages in addition to mnemonic techniques described herein.

In various embodiments, the TMA 115 of the SCD 110 may be configured to resolve a mnemonic for delivery of a message sent from the SCD 110. In various embodiments, the mnemonic may be resolved, such as by the TMA 115 or by a separate service (such as a business/device mnemonic service 130, or “BMS 130,” described below), to a communication address for the DCD 190 in order to facilitate transmission of messages to the DCD 190 without requiring specific knowledge of the communication address by a user. In various embodiments, by including a mnemonic, users may be facilitated in sending messages to a business, a device, and/or another entity that is associated with the DCD 190 more easily than if the users had to know the communication address of the DCD 190.

In various embodiments, mnemonics may include various alphanumeric names that may be used to identify a business, device, or other entity associated with the DCD 190. For example, a mnemonic may include a device name (e.g., “&billshybrid”, “&homewaterheater”), a business name (e.g., “&frankslaundry”, “&hotdogwarehouse”), a personal name (e.g., “&frankrichards”), a description of an industry or service (e.g., “&portlandlaundry”), a motto or tagline for a business (e.g., “&cleanandsupreme”), etc., or an abbreviation thereof. In various embodiments, the TMA 115 may be configured to recognize a mnemonic based on application of a specific identifying character that may be appended to the mnemonic, such as the “&” character used in the examples above. In some embodiments a hashtag or other tag (e.g., “#mnemonic”) may be included in a message to indicate that a mnemonic is present.

In various embodiments, the TMAs 115 and/or 195 may be configured to interact with one or more remotely-disposed services to facilitate techniques described herein. For example, the TMA 115 may be configured to send a resolution request to a business/device mnemonic service 130 (“BMS 130”). In various embodiments, the BMS 130 may be configured to resolve the mnemonic received in the resolution request to a communication address. In various embodiments, the BMS 130 may be configured to perform the resolution by looking up the mnemonic in a mnemonic storage that is included in the BMS 130 (or otherwise communicatively available to the BMS 130). In various embodiments, the BMS 130 may reply to the resolution request with the communication address.

In other embodiments, the TMA 115 may be configured to resolve the mnemonic without making a request of the BMS 130. For example, the TMA 115 may include a mnemonic cache 118 that may be configured to store associations between mnemonics and communication addresses. In various embodiments, one or more associations in the mnemonic cache 118 may be created by the TMA 115 after receipt of a communication address from the BMS 130 in response to a resolution request.

In various embodiments, the TMA 115 may also be configured to interact with a vocabulary service 140 (“VS 140”) to translate abbreviated vocabulary in a message before the message is presented to a user of the DCD 190. In various embodiments, the abbreviated vocabulary may include various combinations of alphanumeric and/or punctuation characters that may be associated with a word or phrase that is associated with the business or other entity associated with the DCD 190. In various embodiments, a special character, such as, for example, a “̂” character, may be appended to the abbreviated vocabulary in order to highlight the abbreviated vocabulary for translation. In other embodiments, a different character, or no character at all, may be used.

In various embodiments, abbreviations may be associated with particular businesses or generally with industries or services. For example, an instance of abbreviated vocabulary for a laundry industry might be “̂dct”, which may translate to “dry cleaning available tomorrow?” while a business-specific instance of abbreviated vocabulary may be “̂iff”, which may translate to “instructions for Frank.” In various embodiments, the business may publish the abbreviated vocabulary so that users may be able to use it when generating messages. In various embodiments, the DCD 190 may be associated with a particular service type, industry, and/or locale in order to provide for the use of abbreviated vocabulary that is not specifically associated with the DCD 190 itself (such as in the example of “̂dct” above).

In various embodiments, in addition to communication with the BMS 130, the TMA 115 may be configured to send a translation request to the VS 140, which may be a remotely-disposed service configured to provide translated text for abbreviated vocabulary. Thus, the TMA 115 may send a translation request to the VS 140, which may include various instances of abbreviated vocabulary. In various embodiments, the VS 140 may be configured to receive entire messages that include the abbreviated vocabulary, and/or to receive only the abbreviated vocabulary itself. In various embodiments, the VS 140 may be configured to look up translated text for the abbreviated vocabulary, such as in a vocabulary storage 145 that is included in the VS 140 (or otherwise communicatively available to the VS 140). In other embodiments, such as described below, the TMA 195 of the DCD 190 may be configured to translate the abbreviated vocabulary by looking up the vocabulary on a vocabulary cache that is associated with the TMA 195. Use of the vocabulary cache is described in greater detail below.

In various embodiments, the DCD 190 may optionally include a message processing module 198 (“MP 198”). The MP 198 may be configured to process and/or perform one or more actions based on the business/device instructions in a message received according to techniques described herein. For example, if the DCD 190 is associated with a particular device, such as a car, the MP 198 may be configured to receive messages directing actions relating to operation of the car, such as, for example, “̂startup” or “̂tempto68”, which may translate to instructions to start the car or turn a car thermostat to 68° F. In the example of a DCD 190 that is associated with a business, the MP 198 may be configured to receive messages associated with business services, such as, for example, “̂accountbalance” or “̂cancelorder”. In various embodiments, the VS 140 may be configured to translate abbreviated vocabulary into instructions which may be understood by the MP 198. In other embodiments, the MP 198 may be configured to directly understand instructions sent to it, which may be demarcated by a specific character and/or sent as plain text. In other embodiments, rather than perform additional processing of the received message, the TMA 195 of the DCD 190 may display the message, such as for review by a user.

Referring now to FIGS. 1-3, example information flows for use cases of mnemonic-based text messaging are illustrated. It may be noted that while particular information flows are illustrated, these flows are not intended to be limiting, either in the order of actions, type of information, or entities involved, and that in other embodiments, other information flows may be utilized.

Referring back to FIG. 1, in various embodiments, the actions of FIG. 1 may occur after receipt by the TMA 115 of a message including a mnemonic for delivery of the message and abbreviated vocabulary. In a first action, a resolution request may be sent to the BMS 130 from the TMA 115 of the SCD 110. The resolution request may contain one or more mnemonics, or indications thereof. Next, at action 2, the BMS 130 may resolve these mnemonics to one or more communication addresses and send the communication addresses back to the TMA 115 of the SCD 110.

Next, at action 3, the TMA 115 may send the received abbreviated vocabulary to the VS 140 for translation. In various embodiments, the abbreviated vocabulary may be sent by itself, or as part of a whole or partial message that includes the abbreviated vocabulary. In response, at action 4 the VS 140 may reply to the TMA 115 with one or more translations of the received abbreviated vocabulary.

Next, at action 5, the TMA 115 may send the translated message to the CS 150, such as using a text messaging protocol, as described above. In various embodiments, the message may be sent by the TMA 115 via the CS 150 using the one or more communication addresses that were received in from the BMS 130. The CS 150 may then, at action 6, send the translated message to the TMA 195 of the DCD 190. The DCD 190 may then display and/or process the received and translated message.

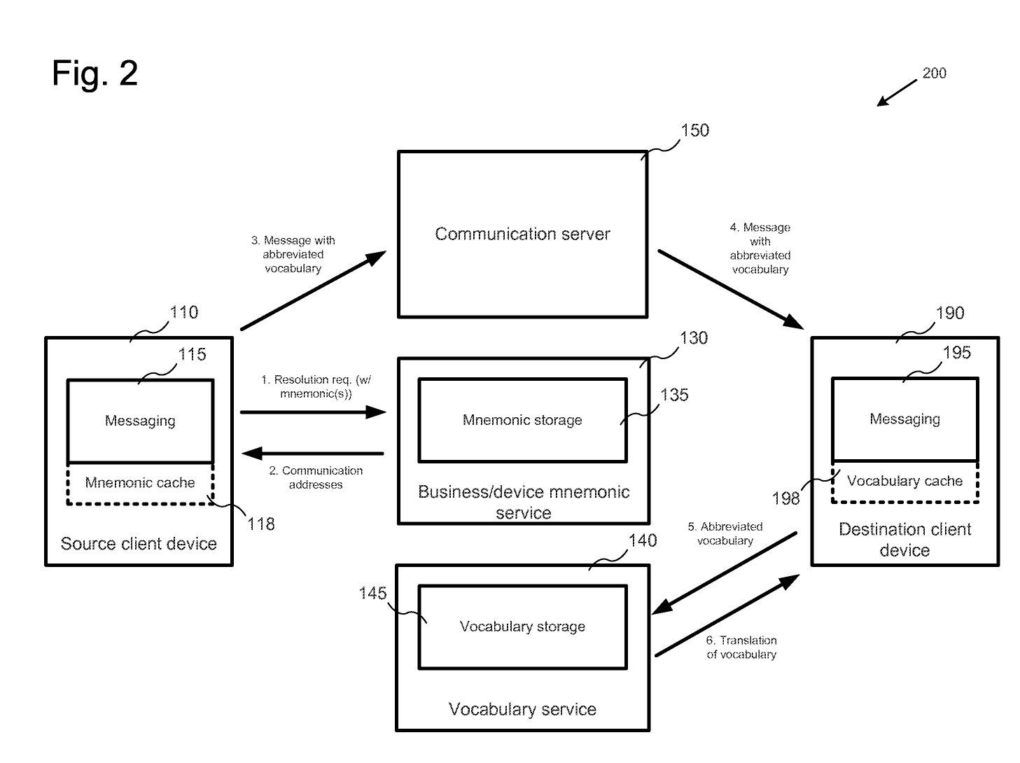

Referring now to FIG. 2, information flows for a second example use case are illustrated. In various embodiments, the actions of FIG. 2 may occur after receipt by the TMA 115 of a message including a mnemonic for delivery of the message and abbreviated vocabulary. However, in the example use case of FIG. 2, translation of abbreviated vocabulary is performed after receipt of a message, not before sending of the message. In a first action, a resolution request may be sent to the BMS 130 from the TMA 115 of the SCD 110. The resolution request may contain one or more mnemonics, or indications thereof. Next, at action 2, the BMS 130 may resolve these mnemonics to one or more communication addresses and send the communication addresses back to the TMA 115 of the SCD 110.

Next, at action 3, the TMA 115 may send the message, which may include untranslated abbreviated vocabulary, to the CS 150, such as using a text messaging protocol, as described above. In various embodiments, the message may be sent by the TMA 115 via the CS 150 using the one or more communication addresses that were received in from the BMS 130. The CS 150 may then, at action 4, send the untranslated message to the TMA 195 of the DCD 190.

Next, at action 5, the TMA 195 of the DCD 190 may send the received abbreviated vocabulary to the VS 140 for translation. In various embodiments, the abbreviated vocabulary may be sent by itself, or as part of the received message that includes the abbreviated vocabulary. In response, at action 6 the VS 140 may reply to the TMA 195 with one or more translations of the received abbreviated vocabulary. The DCD 190 may then display and/or process the received and translated message.

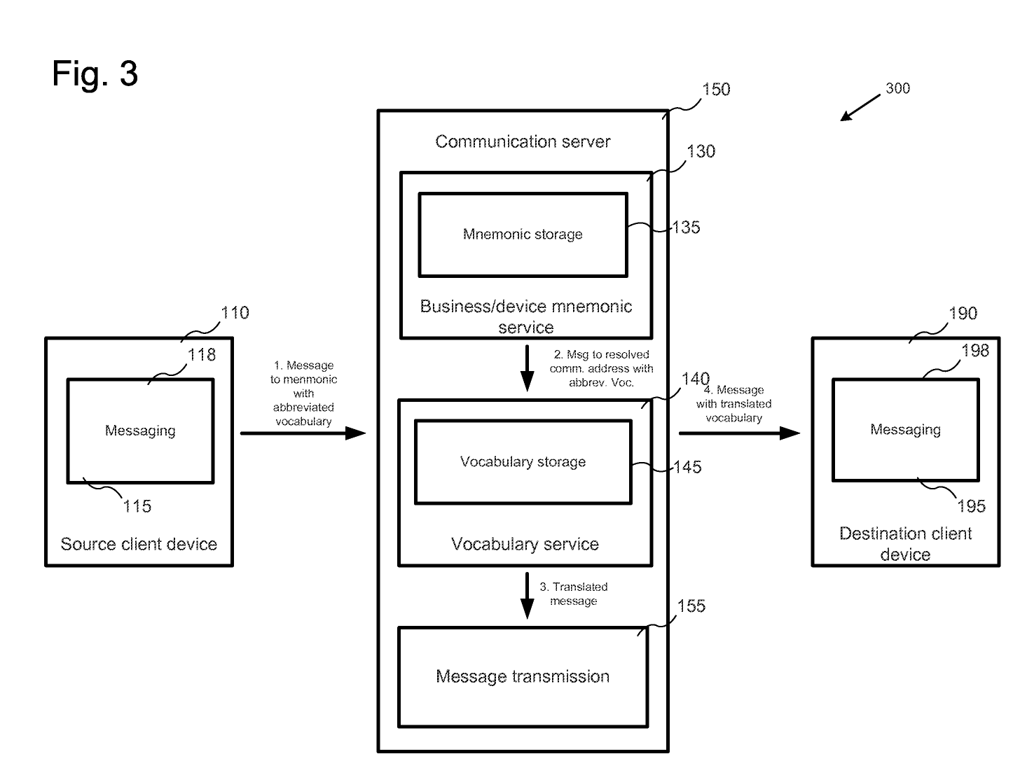

Referring now to FIG. 3, information flows for a third example use case are illustrated. In various embodiments, the actions of FIG. 3 may occur after receipt by the TMA 115 of a message including a mnemonic for delivery of the message and abbreviated vocabulary. However, in the example use case of FIG. 3, resolution and translation of abbreviated vocabulary are performed by the BMS 130 and VS 140 as part of the CS 150, rather than as separate entities. It may be noted that, in alternative embodiments, only one of the BMS 130 or VS 140 may be included with the CS 150—these embodiments are not illustrated for sake of compact explanation, but will be recognized as alternatives on the described embodiments.

In a first action, a message may be sent to the CS 150 by the TMA 115 of the SCD 110, including both mnemonics for the destination of the address, as well as abbreviated vocabulary. In this use case, the TMA 115 may not have knowledge or otherwise not be configured to perform mnemonic resolution or request translation of abbreviated vocabulary. Next, at action 2, the BMS 130 may resolve the mnemonics received in the message and send the message, including any communication addresses, to the VMS 140. The message may still include the abbreviated vocabulary, however.

Next, at action 3, the VS 140 may translate the abbreviated vocabulary and send the message with translated vocabulary to a message transmission module 155. In various embodiments, the message transmission module 155 may be configured to send the message, using a text messaging protocol, to one or more DCDs 190 at action 4. In various embodiments, a message transmission module 155 may also have been used in the example use cases of FIGS. 1 and 2, as well. After transmission of the DCD 190 may then display and/or process the received and translated message, such as using TMA 195.

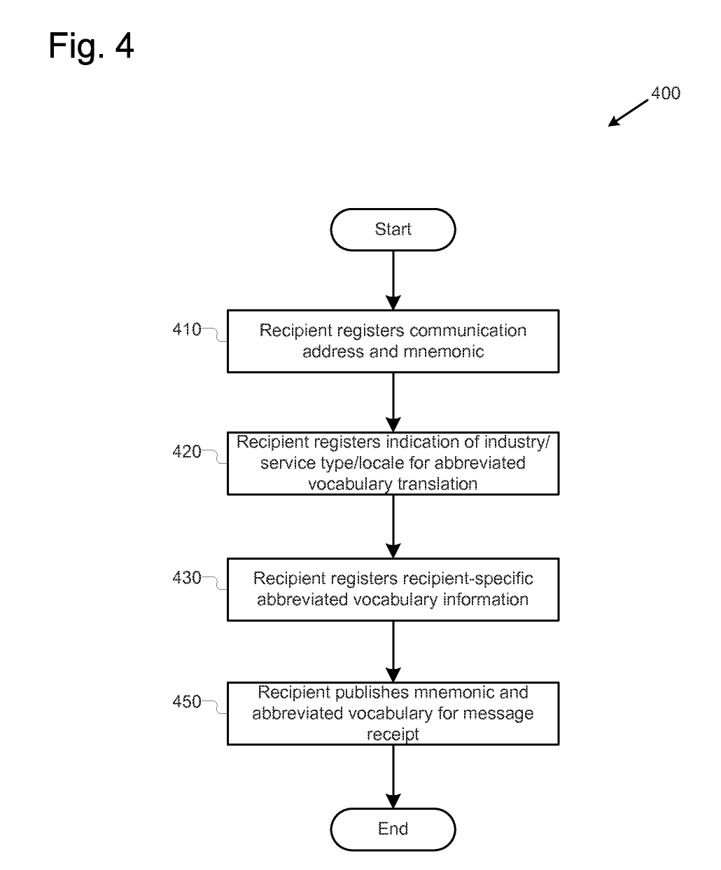

Referring now to FIG. 4, an example process for setting up mnemonic-based text messaging is illustrated in accordance with various embodiments. While FIG. 4 illustrates particular operations in a particular order, in various embodiments, the operations may be combined, split into parts, and/or omitted. In various embodiments, operations of process 400 may be performed through interaction of a recipient associated with a particular CDC 190, such as a person or business. The process may begin at operation 410, where the recipient may register one or more communication addresses and mnemonics with the BMS 130 to be used for later text messaging. In various embodiments, recipient may be a business, and may register communication addresses for one or more DCD 190s associated with the business; in such embodiments, the registered mnemonic may be specific to the business but may not be specific to a particular device (e.g., “&frankslaundry”). In other embodiments, the recipient may register a communication address of a specific device, such as a vehicle or household device associated with the recipient. In such embodiments, the registered mnemonic may be more specific to the device (e.g., “&billshybrid”). In various embodiments, the registered communication address and/or mnemonic may be stored at one or more of the mnemonic cache 118 or the mnemonic storage 135.

Next, at operation 420, the recipient may register with the VS 140 an indication of an industry, service type, and/or locale that may be associated with the registered mnemonic/communication address. For example, the VS 140 may receive an indication that a communication address and/or mnemonic are associated with the dry cleaning industry, making dry-cleaning-related abbreviated vocabulary available to senders sending text messages to that mnemonic in the future. In various embodiments, the registered industry, service, type, and/or locale may be stored at the vocabulary storage 145. In various embodiments, the VS 140 may provide for registration of industry/service type/locale-related abbreviate vocabulary, though this may not be performed for registration of any particular DCD 190.

Next, at operation 430, the recipient may register recipient-specific abbreviated vocabulary information with the VS 140. For example, the recipient may, at operation 430, register abbreviated vocabulary such as “̂iff”, which may translate to “instructions for Frank.” At operation 450, the recipient may publish the registered mnemonic, possibly along with pieces of registered abbreviated vocabulary, to be read by potential senders of text messages. By publishing easier-to-remember mnemonics, communication with the DCD 190, and therefore with the business and/or person, may be facilitated. The process may then end.

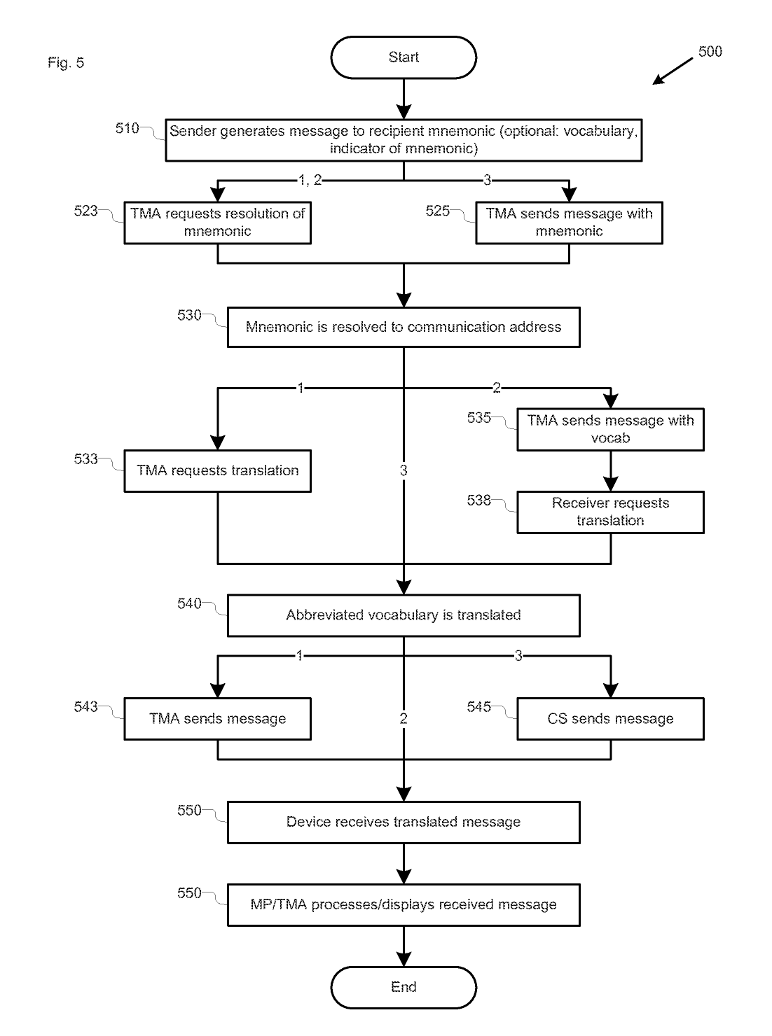

Referring now to FIG. 5, an example process 500 for performing mnemonic-based text messaging is illustrated in accordance with various embodiments. In the example of FIG. 5, the three use cases of FIGS. 1-3 are illustrated . While FIG. 5 illustrates particular operations in a particular order, in various embodiments, the operations may be combined, split into parts, and/or omitted.

The process may begin at operation 510, where a sender, using a SCD 110 generate a message to be sent to a mnemonic, such as a business or device. In various embodiments, the message may include abbreviated vocabulary, and/or may include an indication that a mnemonic is used. Next, in use cases 1 and 2, at operation 523, the TMA 115 may request resolution of the mnemonic. In various embodiments, the resolution may be performed by the BMS 130 or by a local mnemonic cache 118. In the example of use case 3, however, where the CS 150 includes the BMS 130, the TMA may send the message, including the mnemonic, to the CS 150 for transmission to the DCD 190. Next, at operation 530, the mnemonic may be resolved, such as by the BMS 130 or a local mnemonic cache 118, to a stored communication address.

Next, in the example of use case 1, the TMA 115 may request translation of abbreviated vocabulary in the message from the VS 140 at operation 533. However, in the example of use case 2, the TMA 115 may send the message with abbreviated vocabulary to the TMA 195 of the DCD 190 (such as through the CS 150) at operation 535. The receiving TMA 195 may then request translation of abbreviated vocabulary in the message from the VS 140 at operation 538.

In all three use cases, at operation 540, the VS 140 may translate the received abbreviated vocabulary. In various embodiments, the VS 140 may receive the full message sent (or part of the message sent) and reply with the message. In others, only the abbreviated vocabulary may be sent and the VS 140 may reply only with translation of the abbreviated vocabulary. In various embodiments, the abbreviated vocabulary may be translated into text. In various embodiments, the text of the translated vocabulary may be processed by the MP 198 for the DCD 190 to perform one or more actions.

In the example of use case 2, the TMA 195 of the DCD 190 has already received the message at this point. In the example of use case 1, however, at operation 543, the TMA 115 may send the message, including text of the translated vocabulary, to the DCD 190, such as through the CS 150. In the example of use case 3, the CS 150 already has the message, now including text of the translated vocabulary, and so at operation 545, the CS 150 may send the message to the DCD 190.

Next, in all three examples, at operation 550, the DCD 190 may receive the translated message. Then, at operation 560, the MP 198 may process the received message and/or the TMA 195 may display the received/translated message. In various embodiments, the MP 198 may cause the DCD 190 to perform one or more actions based on its processing of the text of the translated vocabulary found in the message. The process may then end.

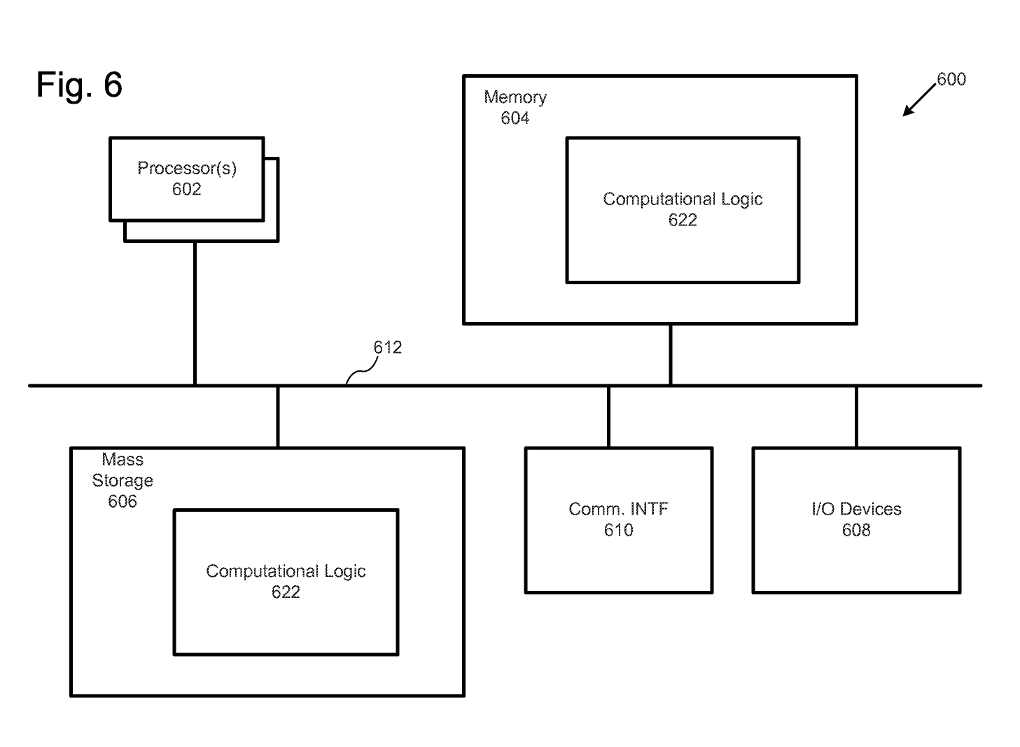

Referring now to FIG. 6, an example computer suitable for practicing various aspects of the present disclosure, including processes of FIGS. 1-5, is illustrated in accordance with various embodiments. As shown, computer 600 may include one or more processors or processor cores 602, and system memory 604. For the purpose of this application, including the claims, the terms “processor” and “processor cores” may be considered synonymous, unless the context clearly requires otherwise. Additionally, computer 600 may include mass storage devices 606 (such as diskette, hard drive, compact disc read only memory (CD-ROM) and so forth), input/output devices 608 (such as display, keyboard, cursor control, remote control, gaming controller, image capture device, and so forth) and communication interfaces 610 (such as network interface cards, modems, infrared receivers, radio receivers (e.g., Bluetooth), and so forth). The elements may be coupled to each other via system bus 612, which may represent one or more buses. In the case of multiple buses, they may be bridged by one or more bus bridges (not shown).

Each of these elements may perform its conventional functions known in the art. In particular, system memory 604 and mass storage devices 606 may be employed to store a working copy and a permanent copy of the programming instructions implementing the modules shown in FIGS. 1-3, and/or the operations associated with techniques shown in FIGS. 1-5, collectively referred to as computing logic 622. The various elements may be implemented by assembler instructions supported by processor(s) 602 or high-level languages, such as, for example, C, that can be compiled into such assembler instructions.

The permanent copy of the programming instructions may be placed into permanent storage devices 606 in the factory, or in the field, through, for example, a distribution medium (not shown), such as a compact disc (CD), or through communication interface 610 (from a distribution server (not shown)). That is, one or more distribution media having an implementation of the agent program may be employed to distribute the agent and program various computing devices.

The number, capability and/or capacity of these elements 610-612 may vary. Their constitutions are otherwise known, and accordingly will not be further described.

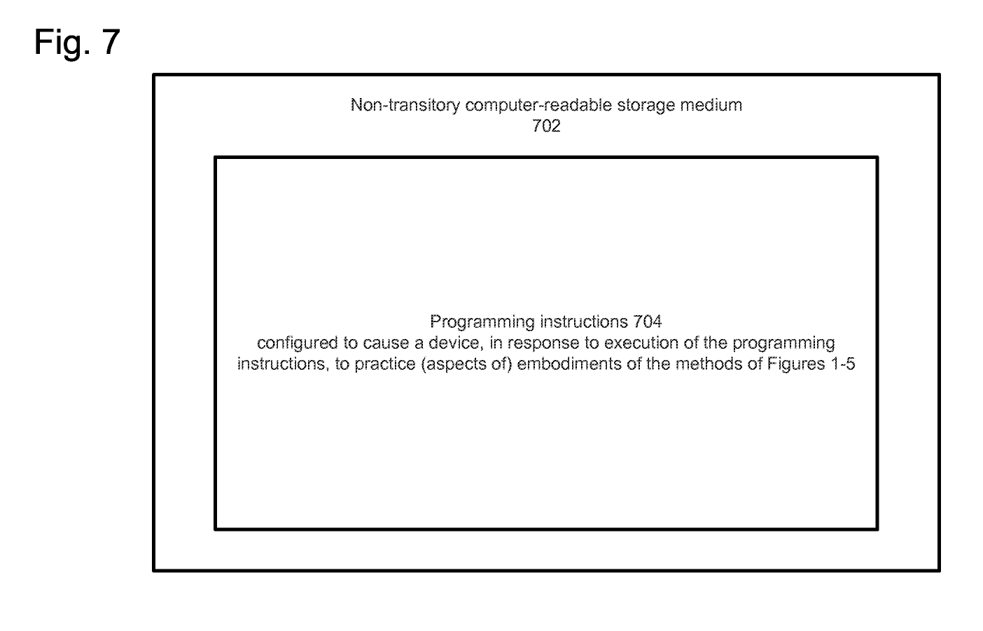

FIG. 7 illustrates an example least one computer-readable storage medium 702 having instructions configured to practice all or selected ones of the operations associated with the techniques earlier described, in accordance with various embodiments. As illustrated, least one computer-readable storage medium 702 may include a number of programming instructions 704. Programming instructions 704 may be configured to enable a device, e.g., computer 600, in response to execution of the programming instructions, to perform, e.g., various operations of processes of FIGS. 1-5, e.g., but not limited to, to the various operations performed to perform mnemonic-based text messaging. In alternate embodiments, programming instructions 704 may be disposed on multiple least one computer-readable storage media 702 instead.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. One or more computer-readable media comprising programming instructions written thereon for facilitating transmission of business or device instruction messages in text by causing a computing system, in response to execution of the instructions by the computing system, to:
receive, with a text messaging application (“TMA”), a text message to be sent to a business or a device in accordance with a text messaging protocol, wherein
the text message includes a mnemonic of the business or device, and one or more business or device instructions to cause the business or device to perform one or more actions; and
send, by the TMA, the text message to the business or device in accordance with the text messaging protocol.

2. The computer-readable media of claim 1, wherein:
the one or more business or device instructions include abbreviated vocabulary of a business or device language of the business or device; and
send comprises send the text message to the business or device such that the text message includes translated text of the abbreviated vocabulary.

3. The computer-readable media of claim 2, wherein send the text message to the business or device comprises:
send a translation request to a vocabulary service operating on a computing server remotely disposed from the computing system, wherein the translation request includes the abbreviated vocabulary;
receive from the vocabulary service, in response to the translation request, the translated text associated with the abbreviated vocabulary; and
send the message, including the translated text, to the business or device.

4. The computer-readable media of claim 3, wherein send the text message further comprises replace the abbreviated vocabulary in the text message with the translated text.

5. The computer-readable media of claim 2, wherein send the text message to the business or device comprises send the message, including the abbreviated vocabulary, to a vocabulary service operating on a computing server remotely disposed from the computing system, the vocabulary service configured to send the text message to the business or device including the translated text of the abbreviated vocabulary.

6. The computer-readable media of claim 1, wherein:
the instructions are further to cause the computing system to resolve the mnemonic of the business or device, by the TMA, to a communication address of the text messaging protocol.

7. The computer-readable media of claim 6, wherein the text messaging protocol comprises an SMS or MMS protocol.

8. The computer-readable media of claim 6, wherein the text messaging protocol comprises a protocol other than SMS or MMS.

9. The computer-readable media of claim 8, wherein resolve the mnemonic to a communication address comprises resolve the mnemonic to an Internet Protocol address.

10. The computer-readable media of claim 6, wherein resolve the mnemonic to a communication address comprises retrieve the communication address from a cache disposed on the computing system.

11. The computer-readable media of claim 6, wherein resolve the mnemonic of the device comprises:
send a resolution request to a device mnemonic service operating on a computing server remotely disposed from the computing system, wherein the resolution request includes the mnemonic of the business or device; and
receive, from the business/device mnemonic service, in response to the resolution request, the communication address.

12. One or more computer-readable media comprising programmable instructions written thereon for facilitating reception and processing of business or device instruction messages in text by causing a computing system of a business or device, in response to execution of the instructions by the computing system of the business or device, to:
receive, by a text messaging application (“TMA”), via a text messaging protocol, a text message, wherein the text message includes one or more instructions for the computing system or the device to perform one or more actions;
determine, based on the received one or more instructions, the one or more actions; and
perform or cause to be performed the one or more actions.

13. The computer-readable media of claim 12, wherein:
the text message includes abbreviated vocabulary of business or device instructions of a business or device language of the business or device; and
the computing system or device is further caused to determine one or more business or device instructions of the received abbreviated vocabulary.

14. The computer-readable media of claim 13, wherein the computing system or device is further caused to retrieve the one or more business or device instructions of the abbreviated vocabulary from a cache disposed on the computing system or device.

15. The computer-readable media of claim 14, wherein determine one or more business or device instructions of the received abbreviated vocabulary comprises:
send a translation request to a vocabulary service operating on a computing server remotely disposed from the computing system or device, wherein the translation request includes the abbreviated vocabulary; and
receive from the vocabulary service, in response to the translation request, translated text of the received abbreviated vocabulary setting forth the business or device instructions.

16. The computer-readable media of claim 12, wherein:
the text message was initially provided with a mnemonic of the business or device, that enabled the text message to be delivered to the computing system or the device; and
the mnemonic of business or the device is registered with a business/device mnemonic service

17. One or more computer-readable media comprising programming instructions written thereon for facilitating transmission of business or device instruction messages in text by causing a communication server, in response to execution of the programming instructions by the communication server, to:
receive a text message from a first text messaging application (“TMA”) operating on a source client device, to be forwarded to a second TMA operating on a destination client device, the text message including a mnemonic of the destination client device or a business associated with the destination client device, wherein the mnemonic has been registered with a business/device mnemonic service;
resolve the registered mnemonic of the business or the destination client device to a communication address of a text messaging protocol; and
forward the message to the business or the destination client device, using the communication address, in accordance with the text messaging protocol.

18. The computer-readable media of claim 17, wherein:
the text messaging protocol comprises an SMS or MMS protocol; and
resolve the registered mnemonic comprises resolve the registered mnemonic to a phone number.

19. The computer-readable media of claim 17, wherein the text messaging protocol comprises a protocol other than SMS or MMS.

20. The computer-readable media of claim 17, wherein receive the text message comprises receive the text message via an SMS or MMS protocol and wherein the text message includes an indicator that the mnemonic is contained in a body of the text message.

21. The computer-readable media of claim 17, wherein resolve the registered mnemonic of the business or the destination client device comprises retrieve the communication address of from a cache disposed on the communication server.

22. The computer-readable media of claim 17, wherein resolve the registered mnemonic of the business or the destination client device comprises:
send a resolution request to a business/device mnemonic service operating on a computing server remotely disposed from the communication server, wherein the resolution request includes the registered mnemonic of the business or the destination client device; and
receive, from the business/device mnemonic service, in response to the resolution request, the communication address.

23. The computer-readable media of claim 17, wherein:
the business or device instructions include abbreviated vocabulary of a business or device language of the business or device; and
the communication server is further caused to replace the abbreviated vocabulary in the text message with translated text of the abbreviated vocabulary.

24. The computer-readable media of claim 23, wherein replace the abbreviated vocabulary in the text message with translated text of the abbreviated vocabulary comprises retrieve translated text for the abbreviated vocabulary from a cache disposed on the communication server.

25. The computer-readable media of claim 23, wherein replace the abbreviated vocabulary in the text message with translated text of the abbreviated vocabulary comprises:
send a translation request to a vocabulary service operating on a computing server remotely disposed from the communication server, wherein the translation request includes the abbreviated vocabulary;
receive, from the vocabulary service, in response to the translation request, the translated text of the abbreviated vocabulary; and
replace the abbreviated vocabulary in the message with the translated text.

26. One or more computer-readable media containing programming instructions written thereon for facilitating transmission of business or device instruction messages in text by causing a computing system, in response to execution of the instructions by the computing system, to:
receive, by a vocabulary service, abbreviated vocabulary of a text message, from a first text messaging application (“TMA”) operating on a source client device or a second TMA operating on a destination client device, wherein the text message is provided to the first TMA as a text message to be sent to the destination client device, or a business having the destination client device, and wherein the message is sent from the first TMA to the second TMA, directly or via the vocabulary service, using a communication address of a text messaging protocol; and
provide or cause to be provided, by the vocabulary service, to the first TMA or the second TMA, translated text of the abbreviated vocabulary.

27. The computer-readable media of claim 26, wherein provide or cause to be provided comprises retrieve translated text for the abbreviated vocabulary from a cache disposed on the computer system.

28. The computer-readable media of claim 26, wherein:
receive abbreviated vocabulary in a text message comprises receive the text message, that includes the abbreviated vocabulary; and
the computing system is further caused to replace the abbreviated vocabulary in the text message with the translated text.

29. The computer-readable media of claim 26, wherein the computing system is further caused to, forward, by the vocabulary service, the text message including the translated text to the destination client device or the business.

30. The computer-readable media of claim 29, wherein:
the text message, in addition to the abbreviated vocabulary, includes a mnemonic of the business or destination client device, registered with a business/device mnemonic service; and
the mnemonic of the business or destination client device resolves to the communication address of the text messaging protocol.
